(19) United States
(12) Patent Application Publication
(10) Pub. No.: US 2013/0038500 A1
(43) Pub. Date: Feb. 14, 2013

(54) SWITCHING ARRANGEMENT FOR AN ANTENNA DEVICE

(71) Applicants: Andrei Kaikkonen, Jarfalla (SE); Ermin Pasalic, Akersberga (SE); Peter Lindberg, Uppsala (SE); Stefan Irmscher, Sollentuna (SE); Axel von Arbin, Taby (SE)

(72) Inventors: Andrei Kaikkonen, Jarfalla (SE); Ermin Pasalic, Akersberga (SE); Peter Lindberg, Uppsala (SE); Stefan Irmscher, Sollentuna (SE); Axel von Arbin, Taby (SE)

(21) Appl. No.: 13/654,004

(22) Filed: Oct. 17, 2012

Related U.S. Application Data
(63) Continuation-in-part of application No. PCT/EP2010/057758, filed on Jun. 3, 2010.

(51) Int. Cl. H01Q 1/50; H01P 5/12

(52) U.S. Cl. 343/852; 333/101

(57) ABSTRACT

Exemplary embodiments are disclosed of switching arrangements for antenna devices. Exemplary embodiments are also disclosed of antenna arrangements and portable radio communication devices including such switching arrangements. An exemplary embodiment includes a switching arrangement for an antenna device operational in at least two frequency bands. In this example, the switching arrangement generally includes a switching device that is switchable into at least a first state and a second state. The switching device includes at least a first port, a second port, and a third port. The first port is connectable to an antenna device. The second port is connected to the first port in the first state. The third port is connected to the first port in the second state. The switching arrangement includes an inductor connected between the first port and ground.

### CROSS-REFERENCE TO RELATED APPLICATION

This application is a continuation-in-part of PCT International Patent Application No. PCT/EP2010/057758 filed Jun. 3, 2010, published as WO2011/150970 on Dec. 8, 2011. The entire disclosure of the above application is incorporated herein by reference.

### FIELD

The present disclosure relates generally to switching devices and more particularly to a switching arrangement for an antenna device operational in at least two frequency bands.

### BACKGROUND

This section provides background information related to the present disclosure which is not necessarily prior art.

Internal antennas have been used for some time in portable radio communication devices. There are a number of advantages connected with using internal antennas, of which can be mentioned that they are small and light, making them suitable for applications wherein size and weight are of importance, such as in mobile phones.

Further, demand for operation in multiple frequency bands are increasing. One solution for providing, e.g., a mobile phone with operation in multiple frequency bands is to connect different matching networks to an antenna device for different frequency bands through a switching device.

### SUMMARY

This section provides a general summary of the disclosure, and is not a comprehensive disclosure of its full scope or all of its features.

Exemplary embodiments are disclosed of switching arrangements for antenna devices. Exemplary embodiments are also disclosed of antenna arrangements and portable radio communication devices including such switching arrangements.

An exemplary embodiment includes a switching arrangement for an antenna device operational in at least two frequency bands. In this example, the switching arrangement generally includes a switching device that is switchable into at least a first state and a second state. The switching device includes at least a first port, a second port, and a third port. The first port is connectable to an antenna device. The second port is connected to the first port in the first state. The third port is connected to the first port in the second state. The switching arrangement includes an inductor connected between the first port and ground.

Another exemplary embodiment includes an antenna device operational in at least two frequency bands. In this example, the antenna device generally includes a radiating element and a switching device that is switchable into at least a first state, a second state, and a third state. The switching device includes at least a first port, a second port, a third port, and a fourth port. The first port is connected to the radiating element. The second port is connected to the first port in the first state. The second port is open. The third port is connected to the first port in the second state. The third port is connected to a matching network, for tuning of multiple frequency bands for the antenna device. The fourth port is connected to the first port in the third state of the switching device. The fourth port is connected to another matching network, for tuning of multiple frequency bands for the antenna device. An inductor is connected between the first port and ground. A parasitic capacitance connects the switching device to ground.

Further areas of applicability will become apparent from the description provided herein. The description and specific examples in this summary are intended for purposes of illustration only and are not intended to limit the scope of the present disclosure.

### DRAWINGS

The drawing described herein is for illustrative purposes only of selected embodiments and not all possible implementations, and is not intended to limit the scope of the present disclosure.

FIG. 1 illustrates an exemplary embodiment of a switching arrangement for an antenna device operational in at least two frequency bands.

### DETAILED DESCRIPTION

Example embodiments will now be described more fully with reference to the accompanying drawings.

For practical reasons, one state of a switching arrangement for an antenna device of a portable radio communication device is often an open state in which one port of a switching device is left unconnected. Further, a switching device often has a parasitic capacitance to ground of about 1 picofarad (pF). For radio communication purposes, this is undesirable because for operation frequencies of about 800 to 1000 megahertz (MHz) such a parasitic capacitance essentially functions as a short-circuit to ground, and the desired effect of an open state is thus destroyed.

Disclosed herein are exemplary embodiments of a switching arrangement for an antenna device, which improve usability of the switching arrangement for an antenna device. This is based on the realization that by providing the switching arrangement with a grounded inductor connected to an antenna device connection port the drawback mentioned above is mitigated.

An exemplary embodiment includes a switching arrangement for an antenna device operational in at least two frequency bands. In this example, the switching arrangement generally includes a switching device that is switchable into at least a first state and a second state. The switching device includes at least a first port, a second port, and a third port. The first port is connectable to an antenna device. The second port is connected to the first port in the first state. The third port is connected to the first port in the second state. The switching arrangement includes an inductor connected between the first port and ground.

The switching arrangement typically comprises a parasitic capacitance connecting the switching device to ground. The inductance of the inductor is selected to together with the parasitic capacitance form a resonance circuit for a desired frequency band, which frequency band thus will not be affected when the switching device is in an open state. The second port of the switching device is preferably open. The third port of the switching device is preferably connected to a matching network, for tuning of multiple frequency bands for the antenna arrangement. The switching device preferably comprises a fourth port connected to the first port in a third state, and is preferably connected to another matching network, for tuning of multiple frequency bands for the antenna arrangement.

Exemplary embodiments are also disclosed of antenna arrangements and portable radio communication devices including such switching arrangements. For example, an exemplary embodiment of an antenna device is operational in at least two frequency bands. In this example, the antenna device generally includes a radiating element and a switching device that is switchable into at least a first state, a second state, and a third state. The switching device includes at least a first port, a second port, a third port, and a fourth port. The first port is connected to the radiating element. The second port is connected to the first port in the first state. The second port is open. The third port is connected to the first port in the second state. The third port is connected to a matching network, for tuning of multiple frequency bands for the antenna device. The fourth port is connected to the first port in the third state of the switching device. The fourth port is connected to another matching network, for tuning of multiple frequency bands for the antenna device. An inductor is connected between the first port and ground. A parasitic capacitance connects the switching device to ground.

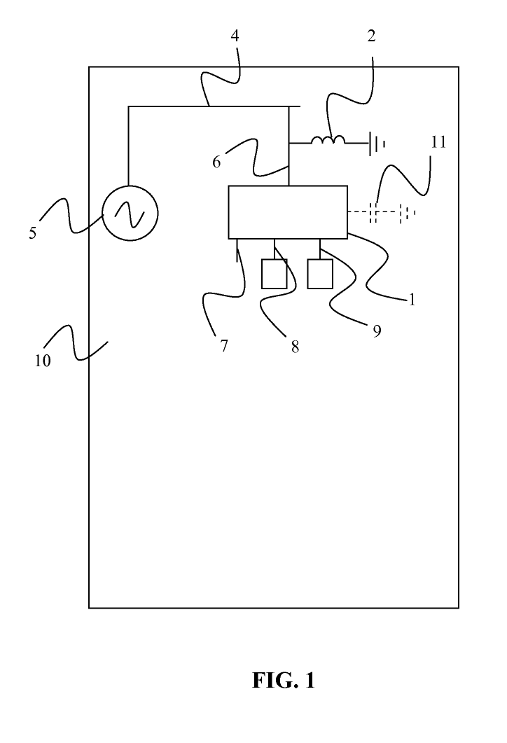

FIG. 1 illustrates an exemplary embodiment of a switching arrangement for an antenna device operational in at least two frequency bands. As shown, the antenna device comprises an antenna radiator 4 and the switching arrangement. The antenna radiator 4 is connected to RF (radio frequency) feeding 5.

The switching arrangement comprises a switching device 1. The switching device 1 is switchable into at least a first state and a second state. In FIG. 1, the illustrated switching device 1 is switchable into a first, a second and a third state.

The switching device 1 comprises a first port 6, a second port 7, a third port 8, and a fourth port 9. The first port 6 is connected to the radiating element 4 of the antenna device. The second port 7 is connected to the first port 6 in the first state. The third port 8 is connected to the first port 6 in the second state. The fourth port 9 is connected to the first port 6 in the third state.

The switching arrangement further includes an inductor 2 connected between the first port 6 and ground of a radio communication device 10 in which the antenna device is mounted. The radio communication device 10 is preferably a portable radio communication device, such as a mobile phone, PDA, or other device utilizing radio communication.

The switching arrangement intrinsically also comprises a parasitic capacitance 11 parasitically connecting the switch device 1 to ground. A typical parasitic capacitance is in the order of 0.5 to 2 pF, generally about 1 pF. The parasitic capacitance 11 affects the antenna device at most when the switch device 1 is an open state, which instead of being perceived as an open state for frequencies of about 800 to 1000 MHz will be perceived as a short-circuited state for those frequencies.

For operation of the antenna device in multiple frequency bands, the third port 8 is connected to a matching network for a frequency band different than 824 to 960 MHz, e.g., 1710 to 1880 MHz. And, the fourth port 9 is connected to another matching network for another frequency band, e.g., 1850 to 2170 MHz. Accordingly, the antenna device may be operable in at least three different bands including 824 to 960 MHz, 1710 to 1880 MHz, and 1850 to 2170 MHz.

By adding the parallel inductor 2 in front of the switch 1, the inductor 2 together with parasitic capacitance 11 forms a parallel resonance circuit, e.g., to improve the switch 1 in open state at the desired frequency band (e.g., 800 to 1000 MHz, etc.). The inductor 2 may be tuned to the desired frequency band to achieve high impedance when the switch 1 is open.

Adding a shunt inductance (e.g., 10 nanohenries (nH), 15 nH, 20 nH, etc.) to the input of the switch 1 helped minimize or at least reduce the effect of parasitic capacitance of the switch 1 in open state and leakage through the switch 1. The inductance of the inductor 2 is preferably selected to together with the parasitic capacitance form a resonance circuit for a desired frequency band, which frequency band thus will not be affected when the switching device is in an open state. By way of example only, it was observed that there were only 2 decibels of isolation due to the effect of a 2 pF parasitic capacitance without any inductor. But there was above 30 decibels of isolation with the addition of 15 nH shunt inductance, which, in turn, increased radiation efficiency. Accordingly, the impact of parasitic capacitance of the switch 1 can be minimized or at least reduced by adding shunt inductance to input of the switch 1. Inductance together with parasitic capacitance creates a parallel resonant circuit, which helps to block leakage of signal around resonant frequency.

The inductor 2 also intrinsically entails an ESD (electrostatic discharge) protection for the antenna device. Accordingly, the inductor 2 can be used as ESD protection of the switch 1.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms (e.g., different materials, etc.), and that neither should be construed to limit the scope of the disclosure. In some example embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values and particular ranges of values (e.g., frequency ranges or bandwidths, etc.) for given parameters are not exclusive of other values and ranges of values that may be useful in one or more of the examples disclosed herein. Moreover, it is envisioned that any two particular values for a specific parameter stated herein may define the endpoints of a range of values that may be suitable for the given parameter (i.e., the disclosure of a first value and a second value for a given parameter can be interpreted as disclosing that any value between the first and second values could also be employed for the given parameter). Similarly, it is envisioned that disclosure of two or more ranges of values for a parameter (whether such ranges are nested, overlapping or distinct) subsume all possible combination of ranges for the value that might be claimed using endpoints of the disclosed ranges.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items. The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally”, “about”, and “substantially” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A switching arrangement for an antenna device operational in at least two frequency bands, the switching arrangement comprising:
a switching device that is switchable into at least a first state and a second state, the switching device comprising at least:
a first port connectable to an antenna device;
a second port connected to the first port in the first state; and
a third port connected to the first port in the second state;
an inductor connected between the first port and ground.

2. The switching arrangement of claim 1, further comprising a parasitic capacitance connecting the switching device to ground.

3. The switching arrangement of claim 2, wherein the inductance of the inductor is selected together to with the parasitic capacitance form a resonance circuit for a desired frequency band.

4. The switching arrangement of claim 1, wherein the second port is open.

5. The switching arrangement of claim 1, wherein the third port is connected to a matching network.

6. The switching arrangement of claim 1, wherein the switching device comprises a fourth port connected to the first port in a third state.

7. The switching arrangement of claim 6, wherein the fourth port is connected to a matching network.

8. The switching arrangement of claim 1, wherein:
the switching arrangement further comprises a parasitic capacitance connecting the switching device to ground; and
the inductor has an inductance that together with the parasitic capacitance form a resonance circuit for a desired frequency band that will not be affected when the switching device is in an open state;
the second port is open;
the third port is connected to a matching network, for tuning of multiple frequency bands; and
the switching device further comprises a fourth port connected to the first port in a third state of the switching device, the fourth port connected to another matching network, for tuning of multiple frequency bands.

9. The switching arrangement of claim 1, wherein:
the switching arrangement intrinsically includes a parasitic capacitance parasitically connecting the switching device to ground; and/or
the inductor intrinsically includes an electrostatic discharge protection for the antenna device.

10. An antenna arrangement comprising the switching arrangement of claim 1.

11. The antenna arrangement of claim 10, wherein the antenna arrangement comprises a radiating element and the first port of the switching device is connected to the radiating element.

12. A portable radio communication device comprising the switching arrangement of claim 1.

13. An antenna device operational in at least two frequency bands, the antenna device comprising:
a radiating element;
a switching device is switchable into at least a first state, a second state, and a third state, the switching device comprising at least:
a first port connected to the radiating element;
a second port connected to the first port in the first state, the second port is open;
a third port connected to the first port in the second state, the third port connected to a matching network, for tuning of multiple frequency bands for the antenna device; and
a fourth port connected to the first port in the third state of the switching device, the fourth port connected to another matching network, for tuning of multiple frequency bands for the antenna device;
an inductor connected between the first port and ground; and
a parasitic capacitance connecting the switching device to ground.

14. The antenna device of claim 13, wherein the inductor has an inductance that together with the parasitic capacitance form a resonance circuit for a desired frequency band that will not be affected when the switching device is in an open state.

15. The antenna device of claim 13, wherein the inductor together with parasitic capacitance form a parallel resonance circuit.

16. The antenna device of claim 15, wherein the inductor is configured such that the parallel resonance circuit formed by the inductor and the parasitic capacitance helps reduce the effect of parasitic capacitance of the switching device in an open state and/or helps block leakage of signals through the switching device around a resonant frequency of the antenna device.

17. The antenna device of claim 13, wherein the inductor provides an shunt inductance added to an input of the switching device, which shunt inductance together with the parasitic capacitance creates a parallel resonant circuit.

18. The antenna device of claim 13, wherein:
the third port is connected to the matching network for a frequency band different than 824 to 960 MHz; and
the fourth port is connected to another matching network for another frequency band;
whereby the antenna device is operable in at least three different bands including 824 to 960 MHz.

19. The antenna device of claim 14, wherein the antenna device is operable in at least three different bands including 824 to 960 MHz, 1710 to 1880 MHz, and 1850 to 2170 MHz.

20. A portable radio communication device comprising the antenna device of claim 13.
